(19) United States
(12) Patent Application Publication
(10) Pub. No.: US 2026/0288161 A1
(43) Pub. Date: Sep. 24, 2026

(54) PACKAGING MACHINE SYSTEM WITH AGVS AND METHOD FOR CONTROLLING SAME

(71) Applicant: Gerhard Schubert GmbH, Crailsheim (DE)

(72) Inventor: Volker Haaf, Frankenhardt (DE)

(73) Assignee: Gerhard Schubert GmbH, Crailsheim (DE)

(21) Appl. No.: 19/479,796

(22) PCT Filed: May 2, 2024
(86) PCT No.: PCT/EP2024/062071

§ 371 Date: Oct. 29, 2025

(30) Foreign Application Priority Data
May 2, 2023 (DE) 10 2023 111 236.8

(51) Int. Cl. G05D 1/667; B25J 5/00; B60D 1/36; B60L 50/40; B60L 50/60; B60L 53/10; B60R 19/54; B65B 5/10; B65B 35/16; B65B 57/10; B65B 65/00; G05D 1/225; G05D 1/244; G05D 1/249; G05D 1/698; G05D 1/85; G05D 105/28; G05D 107/70; G05D 111/50

(52) U.S. Cl. CPC G05D 1/667; B25J 5/007; B65B 5/105; B65B 35/16; B65B 57/10; B65B 65/006; G05D 1/225; G05D 1/2446; G05D 1/249; G05D 1/6987; G05D 1/857; B60D 1/36; B60L 50/40; B60L 50/60; B60L 53/10; B60R 19/54; G05D 2105/28; G05D 2107/70; G05D 2111/52

(57) ABSTRACT

For a highly flexible packaging machine system, a transport system consisting of remote-controlled, simple and inexpensive AGVs is used to transport the products or the primary packaging, both between the individual machine modules that can be set up freely in a hall and between the possibly multiple workstations within a machine module, instead of conveyor systems such as conveyor belts or transmodules that are permanently linked to this machine module. Even elevated tracks for the AGVs are easier to set up and convert between repositioned machine modules than conveyor belts or transmodules, especially if they consist of individual modules.

### I. FIELD OF APPLICATION

The invention relates to a packaging machine installation and, in particular, to the transport system within this installation for the products or packages into which the products are to be inserted.

### II. TECHNICAL BACKGROUND

The purpose of a typical packaging machine today is often to convert the products delivered by a production machine on a product conveyor into packaging, such as cartons, in the exact position, which is done by means of so-called robot lines.

Open primary packaging such as tray-shaped trays—which are erected from flat cardboard blanks upstream but already inside the packaging machine and fixed in three dimensions—run on a container belt, usually parallel to the product belt in the direction of passage through the packaging machine.

Multiple transfer robots are usually arranged one behind the other as handling units, each of which picks up one or more products from the product conveyor and transfers them to the primary packaging, such as the tray, on the container conveyor.

Further downstream, these primary packs are often transferred in one or more layers into secondary packs, such as open-top cartons, which is also usually done using transfer robots.

Even further downstream, such secondary packaging is often combined into tertiary packaging, for example stacked on pallets, usually also using robots.

The necessary handling processes are carried out at the individual work stations—e.g. tray separator, blank separator, carton erector, carton closer, tray filler, carton filler, palletizer—within the packaging line.

In addition to the aforementioned product belt and/or container belt, i.e. conveyor belts, which generally extend over sections of the entire length of the packaging line, the transport system for this can also include rail-bound carriages, whereby these rails—which can be physically or virtually designed as invisible guiding devices—also generally extend along the entire length of the packaging line.

Although in the latter solution the carriages can already be moved independently in front of each other along the guide rails, such transport systems are still comparatively inflexible, as these carriages cannot overtake each other, for example, cannot deviate from the guide rails and are also relatively expensive to purchase, so that the number of carriages used is as limited as possible and the carriages therefore do not offer any significant buffer option for packaging lying on them, for example.

Particularly in the event of a change in the work order, not only in the form of a change in the product to be handled, but also a fundamental change in the processing or handling tasks with regard to the product and/or the packaging process, such known transport systems are unsuitable, as they require a complex conversion of the conveyor belts or guide rails or even a new setup within the packaging machine.

In addition, these transport systems are not suitable for spontaneously ejecting faulty products or outer packaging from the packaging machine at different points, unless they have been designed in this way from the outset.

In production plants, on the other hand, so-called driverless transport systems are known, in which driverless transport vehicles (AGVs) transport products such as components or assemblies from a warehouse to a workstation or between workstations, often outside the secured machine racks of the workstations.

Such AGVs are usually large and heavy and can carry loads of 50 kg and more, but above all they are usually autonomous vehicles equipped with a lot of sensors, their own on-board control system, often even on-board navigation with position determination based on the surroundings via on-board cameras and collision protection systems, and are therefore expensive and also heavy, although a higher-level central control system is available.

Such AGVs usually determine their spatial position automatically using sensors and reference points and transmit this to the central control system, which usually assigns transport orders with a starting point and destination point as well as a starting time and destination time, but often leaves the navigation in between to the on-board control system of the AGV, as well as collision avoidance.

For economic reasons alone, however, such upgraded AGVs are unsuitable for the transportation of relatively small and light goods in large numbers, particularly within a packaging machine and/or between individual workstations.

### III. DESCRIPTION OF THE INVENTION

### a) Technical Task

It is therefore the task according to the invention to provide a packaging machine system with a highly flexible transport system with driverless, non-rail-bound transport vehicles, whereby the AGVs are so small, light and simple and can therefore be manufactured so cost-effectively that they can be used in large numbers instead of the known rail-bound transport systems for transporting products or outer packaging at least within the packaging machine. The task is also to provide a suitable operating method for such a packaging machine and its transport system.

### b) Solution of the Task

This task is solved by the features of claims 1 and 12. Advantageous embodiments are shown in the subclaims.

The statements made below with regard to the packaging machine system also apply mutatis mutandis to the process for operating this system and vice versa.

A generic machine system for filling primary packaging with products or filling secondary packaging with already filled primary packaging comprises on the one hand at least one, generally multiple, machine modules, as well as a transport system for transporting at least one item to be transported, such as a product or packaging, either between the individual machine modules or between the individual workstations, multiple of which may also be located within a machine module.

Such a workstation has at least one movable handling unit with a tool with which a product or packaging can be handled or processed.

For the purposes of the present invention, these handling units are referred to as robots, without limiting the type of handling unit to such an industrial robot.

The individual machine modules are usually locked on the outside during operation, for example by safety doors that shut down the workstations inside as soon as such a safety door is opened, as there is then a risk of a person entering or reaching in and being injured by moving parts of the workstation.

With regard to the transport system, it is essential that it comprises a large number of remote-controlled, driverless transport vehicles for transporting a transport good, whereby the driverless transport vehicles—hereinafter referred to as AGVs for short—can be moved independently of each other in a controlled manner, i.e. they can travel on an approximately horizontal driving surface in any direction and at any time, and can also overtake each other, whereby collisions between the AGVs should of course be avoided.

The present invention also includes transportation systems with hovering or flying AGVs instead of mobile ones, which is to be subsumed under the term “mobile” or “mobile”.

The AGVs are controlled by a central control system located away from these vehicles, which is connected to the AGVs via a wireless signal.

To enable the central control system to determine the position as well as the rotational position of the AGVs viewed from above—collectively referred to as the spatial position—at any time, the transport system comprises position detectors, usually cameras, which are connected to the central control system and are usually attached to high points on the packaging machine system, and with which the spatial position of the individual AGVs can be determined by the central control system and is therefore known to the central control system.

When the AGV is loaded, the spatial position of the transported goods on it, such as a carton, which is the decisive factor, and/or the spatial position of the supporting AGV is determined.

Theoretically, the spatial positions can be determined using a single position detector located centrally above the packaging machine system. However, due to visual obstructions caused by temporary or permanent obstacles, multiple position detectors are generally used and their results are offset against each other, for example using triangulation methods, in order to be able to determine the position of each AGV and its transported goods at any time.

According to the invention, the central control system is designed in such a way that it is not only able to control the AGVs by transmitting travel path commands to them, but is also able to control the movements of the handling units, usually robots, in the workstations of the machine modules in a correspondingly timed manner, i.e. synchronously, usually robots, in the work stations of the machine modules in the appropriate time sequence, i.e. synchronously, for example when an AGV loaded with an empty carton has approached a work station in the form of a carton filler to fill it with products or primary packaging.

To control other moving parts of the packaging machine system, such as an entry gate into a machine module for AGVs, the central control system must know their spatial positions at all times.

Preferably, the position of the AGVs is determined at very short intervals, usually less than 1 second, often less than 1/10 second, which is sufficient at a maximum travel speed of the AGVs of around 1.5 m/s or around 6 m/s to control the entire system without collisions between the AGVs.

It is obvious that such a packaging machine system, referred to below as a system for short, can be used very flexibly, as the AGVs can move to different machine modules and different workstations within them depending on the work order—as some machine modules contain multiple workstations such as carton erectors and carton fusers—in any order and can therefore process different work orders.

As a rule, the driving surface for the AGVs is the floor of the corresponding hall, but driving surfaces that are higher than the floor are also possible, for example driving surfaces that run on top of each other on multiple floors, although this increases the design effort and costs.

For a system with such a transport system to be economically feasible, the costs of the individual AGV must be kept very low, as the AGVs are generally required in large numbers if they are to replace conveyor belts and track-bound vehicles.

For this purpose, the AGVs are designed to be less complex and therefore more cost-effective.

They may contain an on-board control system, but a navigation system that can determine the current spatial position of the individual AGV and can automatically create the route to a specified destination and a corresponding route command, including local and time specifications for the AGV, is only available on the central control system side, i.e. as part of the central control system, and not on the individual AGV.

The on-board control system of the AGV, on the other hand, is designed in such a way that it can only control the travel drive accordingly on the basis of such a travel path command received from the central control system, so that the travel path specified by the travel path command is traveled in accordance with the travel path command in terms of time and location.

It is irrelevant whether the route command sent to the AGV by the central controller already contains the control commands for the individual motors of the drive or only the route, and the on-board controller automatically generates the control commands for the drive.

With regard to the method for operating a packaging machine system and in particular a transport system with a central controller and driverless, remote-controlled transport vehicles which can be moved freely and independently of one another in all directions for transporting a transport item between individual machine modules or between individual work stations within a machine module, in which the central controller comprises position detectors for determining the instantaneous spatial position of the individual AGVs, in particular a packaging machine system according to one of the preceding claims, the central control unit monitors the spatial positions and, in particular, the instantaneous movements with respect to direction and speed and/or acceleration of the AGVs and, in particular, of the transported goods lying thereon centrally and in real time, and the handling units, in particular robots, are controlled centrally, in particular by the central control unit, in synchronization with, i.e. in timing with, the spatial positions and, in particular, movements of the AGVs.

To control the AGVs, each AGV receives route commands from the central controller, preferably for the entire route from the current position of the AGV to the destination specified by the central controller, whereby the route command for this can include direct drive commands for the drive unit, in particular for each individual drive motor of the AGV.

Alternatively or additionally, the drive commands for the travel drive can each contain an energy supply profile as a function of time, in particular from the start time, whereby not only the travel path, but also the speed and accelerations of the AGV with which this travel path is traveled are also defined.

In order to keep the AGVs reliably on their specified route in terms of time and location, the central control system carries out a target/actual comparison of the room position of the AGV at short intervals and, if the actual room position deviates from the target room position, which is located on the target route, the central control system sends a correction travel command to the AGV, with the help of which the AGV does not necessarily travel to its current target room position, but does travel to the target route, possibly to a point on the target route that is already downstream from the current target room position.

If the situation within the system changes, for example due to the movement of non-stationary obstacles such as other AGVs, the central control system can send corrected route commands to the AGV at any time for the remainder of the route not yet traveled.

Malfunctions can of course occur during operation of the transport system:

If the position sensors, usually cameras, fail, whether due to a technical defect or partial shadowing, the central control system can no longer or temporarily no longer determine the spatial positions of all AGVs.

In this case, the onboard control unit is used to determine the actual position of the AGV based on the control commands issued to the drive unit by the central control unit since the last target/actual comparison of the spatial position, which, when added to the last actual spatial position determined by the central control unit, result in the current actual position of the AGV if no falsifying factors such as slippage of the drive wheels in relation to the ground, etc. occur.

Instead of the control commands issued to the traction drive during this period, the wheel movements of the traction drive carried out during this period and recorded by the on-board control system can also be used directly, which at least rules out any falsifying influences between the motor and wheel.

If, on the other hand, the wireless signal connection between the central controller and one or more AGVs fails and the AGV knows the specified destination but lacks some or all of the necessary route commands to reach the destination from the location from the start of the signal connection failure, the on-board controller will attempt to reach the destination at least via the straight route or a more precisely known, non-straight route specified by the central controller between the current spatial position of the AGV and issue corresponding control commands to the traction drive.

Preferably, the on-board control unit can comprise an acceleration sensor, also known as an inertial sensor, which determines the acceleration in terms of magnitude and direction at least in all directions of the driving surface of the AGV—in the case of a driving surface with multiple floors also in the vertical direction—and these are also stored by the on-board control unit.

If the position sensors fail and the central control system is therefore unable to carry out a target/actual compensation and determine the current actual position of an AGV, the on-board control system can determine the current actual position of the AGV very precisely based on the actual position determined during the last target/actual compensation using the acceleration profile recorded since then.

Furthermore, if the signal connection between the central controller and the AGV and the known destination fails, but there are no complete travel path commands from the central controller, the AGV can travel the specified path or alternatively the straight path from the current actual spatial position of the AGV to the destination in a controlled manner by the on-board controller issuing corresponding control commands to the travel drive, but on the way to the destination, the actual position of the AGV is determined on the basis of the acceleration profile recorded since the last target/actual comparison, i.e. the last determination of the actual spatial position of the AGV by the central controller, and in the event of a deviation, the AGV is directed to the planned path, in particular the straight path to the destination, by means of corresponding travel path commands.

The central controller does not necessarily have to inform the AGV of its destination, e.g. a specific position, such as a waiting position within a machine module, from the outset. Instead, it can divide the planned route into route sections and provide the AGV with route commands only for the next or some of the next route sections. This is due to the consideration that sections of the route that are very far ahead cannot yet be sensibly planned at the start time of the entire route, as the situation in the system may have changed considerably by then.

For this purpose or additionally, the entire possible driving area for the AGVs, in particular by the central control system, can be virtually divided into sectors, for example in a grid-like manner by sectors arranged in columns and rows, which are then usually rectangular, and the route commands for the AGVs can be defined sector by sector and transmitted to the AGVs, for example only for one or a few sectors to be traveled through in advance.

In particular, a transfer of an AGV from one sector to the next can be defined both in terms of location and time and controlled by the central control system by means of a target/actual comparison.

Dividing the driving surface area into individual sectors in this way makes it easier for the central control system to avoid collisions.

Preferably, the spatial position of the AGV is determined as accurately as possible by the central control system, preferably not by means of position sensors in the form of cameras but, for example, by means of special positioning devices at the loading point in a work station, which can work more accurately than the position sensors, which can usually only determine the position/or the rotational position of the AGV to an accuracy of /−5 cm or /−3°.

Preferably, the spatial position of the load on the AGV is also determined immediately after loading, preferably before the AGV has moved between the position determination before and the spatial position determination of the load after loading, so that the spatial position difference between the transported goods and the AGV can be determined from this by the central control unit, for example the offset between the center—be it the geometric center or the center of gravity—of the load and the center of the AGV, in particular its storage surface, viewed from above.

This spatial position difference can be used later if, for example, the loaded AGV has to approach an unloading station very precisely, but exact positioning is only possible with the aid of a positioning device at the unloading point to which the AGV, but not its transported goods, responds, because then this positioning difference must also be taken into account in order to bring the transported goods into the desired actual position there.

The system, in particular the transport system, must be technically equipped accordingly for the procedure described:

As mentioned above, the central control system and/or the on-board control system should therefore be designed in such a way that they are able to recognize the actual position of an AGV by means of the position sensors and, in the event of a deviation from the target position—which should be on the target travel path—send a correction travel command to the AGV as a target/actual comparison, with the aid of which the AGV returns to the target travel path value. The AGV does not necessarily have to drive directly to the target position that matches the determined actual position, as it can be more efficient and save distance to drive to a position further downstream from the target path instead.

The central controller and/or the on-board controller should also be designed in such a way that if the position sensors of the central controller fail, the on-board controller is able to determine the current actual position of the AGV based on the control commands issued by the central controller, the on-board controller, to the drive or the specific wheel movements of the drive that have taken place since the last target/actual comparison of the spatial position of the AGV, provided these have been recorded.

This is because if the spatial position is known at the time of the last target/actual comparison, the presumed current position of the AGV can be determined from there by adding the actual wheel movements or the corresponding control commands to the travel drive, whereby interference effects such as slippage between the wheels and the ground etc. are of course not taken into account in this calculation.

Alternatively or additionally, if the AGV is equipped with an acceleration sensor, the on-board control unit can determine the current actual position of the AGV using the acceleration profile of the AGV recorded since the last target/actual comparison with this acceleration sensor.

The acceleration profile refers to the accelerations that occurred during this period, which must be recorded in terms of magnitude and direction, and from which it is possible to calculate how fast the AGV traveled in which direction during which periods, which results in the total distance traveled. For example, zero acceleration over a certain period of time means that the vehicle has been traveling at a constant speed during this period of time, namely continuously at the speed and in the direction in which it was traveling at the beginning of the period of time in which the acceleration was zero.

The central control system and/or the on-board control system should also be designed so that if the signal connection between the central control system and the AGV and known destination fails, but no further travel commands to the destination are complete, the on-board control system is able to calculate at least the straight path between the current position of the AGV and the destination and issue corresponding control commands to the travel drive.

The onboard control system can also check the current position of the AGV on the way to the destination using the acceleration profile recorded since the last target/actual comparison with an acceleration sensor, which has the advantage that the calculation based on the acceleration profile reflects the actual movement of the AGV, i.e. slip between the wheels and the ground is already taken into account, for example.

In addition to the remote-controlled electric drive, the AGVs should have an energy storage system and communication equipment for the wireless data connection with the central control system. Supercups, i.e. high-capacity electrical capacitors, are preferred as energy storage devices because they can be recharged in just a few seconds. In addition, there should be a conventional battery that is kept constantly charged and is dimensioned so that its energy content can be used to drive the AGV from any point in the system to the next accessible recharging station in the event that the Supercups are empty or do not work.

In terms of sensor technology, the AGVs should have at most one such environmental sensor, in particular a camera, for detecting the environment, whose image evaluation unit is at most capable of recognizing a predefined environmental pattern, such as a barcode or QR code, but no unknown environmental features. Since cameras are now very inexpensive, but the image evaluation units can cost multiple 1000 € if they are to be capable of evaluating images of unknown environmental patterns, this leads to a drastic reduction in the overall costs of the AGV.

The travel drive usually comprises electric motors.

The energy supply of the AGVs, both for these electric motors and for the other existing electrical equipment such as an electrical or electronic control system or the communication equipment, is preferably provided by means of electrical super-caps, i.e. high-performance capacitors that can be charged within a few seconds and for which recharging devices are provided, in particular at the waiting positions, i.e. approach positions for the AGVs at the work stations, recharging devices are sometimes provided at these, whether contacting or contactless, in particular inductive, recharging devices, so that when an AGV remains at a work station, its super-caps are automatically recharged.

As an emergency power supply, an AGV can also have an emergency battery, but this only needs to have a low capacity and therefore a low weight, and only needs to be sufficient to drive the AGV to the nearest recharging facility when the Super Cups are empty.

Furthermore, the machine modules, and in particular their workstations, should have a preferably at least partially lockable safety gate for the entry of an AGV, which is only opened for the entry of the AGV and is otherwise closed to such an extent that it is not possible for a person to reach into the workstation.

Preferably, a target marking that can be scanned by the AGV should be present in the entry and/or exit area of the machine modules and/or their workstation and the AGV should have a target sensor, for example a camera, in order to recognize the target marking and, in particular, to be able to determine the position of the AGV relative to the target marking and report it to the central control system, in particular by locating the target sensor on the underside of the AGV.

Instead of a complex image evaluation unit, a camera provided for this purpose can only comprise such an image evaluation unit that can only recognize a predetermined type of target marker, for example a QR code, which makes the image evaluation unit much simpler and less expensive.

In particular, each AGV can also have such a target marking for scanning by the position sensors of the central controller, which makes it easier to determine the position.

The position detectors of the central controller are located inside the system, preferably outside the machine modules, but can also either detect inside the machine modules or additional position detectors are stationary in the machine module.

Such target markings can also be present at the approach positions, in particular waiting positions for the AGVs at the individual workstations, and facilitate the exact positioning of the AGV to the workstation, in particular by the central control system, by means of a corresponding target sensor on the side of the AGV.

Preferably, the image evaluation of the cameras used as position sensors to determine the position of the AGVs as well as to determine the position of-temporary or permanent-obstacles is carried out by the central control system using artificial intelligence.

The driving surfaces for AGVs can be arranged in multiple levels one above the other, whereby the lowest level can still be the floor of the corresponding hall.

To move from one floor to another, a controlled lifting device, such as an elevator, is preferably available, the use of which is included in the travel path commands of the central control system in terms of location and time.

The driving surfaces, especially on the upper floors, are then physically formed driveways consisting of individual combinable, in particular elevated driveway modules that can be easily assembled.

The driving surfaces for the AGVs can also be moving driving surfaces, for example conveyor belts, onto which the AGVs drive and can therefore be moved very quickly over long distances, especially if these moving driving surfaces are sealed off from the surroundings so that people moving in the hall cannot come into contact with an AGV standing on the moving driving surface or also moving.
Guard rails or rails for the AGVs can be provided along the travel paths for the AGVs on one or both sides or on the ground, along which they travel, in particular in contact, in order to facilitate the control of the AGVs along straight, long paths.
Driven drivers for the AGVs can be provided on the system side along the travel paths for the AGVs, which take the AGVs along a predefined movement path, for example pushing them in front of them, for example to conserve the battery of the AGVs during long trips or to allow many AGVs to travel in very short intervals one behind the other.

Preferably, the driving surfaces for AGVs are at least visually separated from the walking surfaces for people, and in particular also physically separated.

The drive unit of an AGV is preferably designed so that the AGV can turn on the spot and move from a standing position in any direction. So-called all-direction wheels are available for this purpose, which are preferably installed on an AGV with intersecting axles.

Individual AGVs can also be equipped for special tasks:

For example, an AGV can have its own handling unit, in particular a robot, in order to be able to load or unload itself, whereby such a robot preferably also receives its movement commands in terms of time and location from the central controller.

An AGV can also have its own cleaning unit, in particular a suction unit or a brush unit, in order to clean the driving surfaces, whereby such a cleaning unit also preferably receives its movement commands from the central control unit.

As a rule, the top of an AGV is used as a storage surface for goods to be placed on it.

In addition or instead, an AGV can also have a trailer coupling for-in particular automatic-coupling of a trailer or another AGV, and the top of the trailer can be used as a storage surface-either as the only surface or in addition to the AGV—for goods to be transported.

Two coupled AGVs can be moved together synchronously to pick up large loads.

A special procedure for operating such a system consists of converting the packaging machine system.

In contrast to today's workstations, which are interlinked via permanently installed conveyor systems, a system according to the invention can have machine modules with their own base frames and safety barriers on the outer circumference for certain work tasks of the one or more workstations contained therein, which are transportable, can be easily moved within a hall with the aid of a forklift truck, for example, and only need to be supplied with the required media such as electricity or compressed air, for example from the hall ceiling.

Even fundamental changes to a work order can then be realized, for which the desired new work order is entered into the central control system.

The transportable machine modules-these may be the same machine modules that were previously present in the hall, or new machine modules may be added or others removed from the hall-are then set up in the hall, whereby their optimum position, for example in terms of short travel distances for the AGVs, is preferably determined in advance by the central control system.

The machine modules only need to be roughly positioned in the hall, for example in the decimeter or centimeter range, as their exact spatial position is then determined by means of position sensors in the central control system-in particular the same position sensors that are used to determine the actual position of the AGVs.

As soon as these room positions are known, the central control system can first determine the actual room position for each AGV for the corresponding order and then create the route commands and issue them to the AGV, whereby the central control system preferably also automatically determines the number of AGVs required to carry out the work order beforehand and releases and activates them.

If the travel surfaces consist of physical travel paths, and these are composed in particular of travel path modules, the central controller can also define the positions for the machine modules in such a way that in particular the distances between them can be filled exactly by an integer multiple of the length of such travel path modules.

### C) EMBODIMENT EXAMPLES

Embodiments according to the invention are described in more detail below by way of example. Figures:

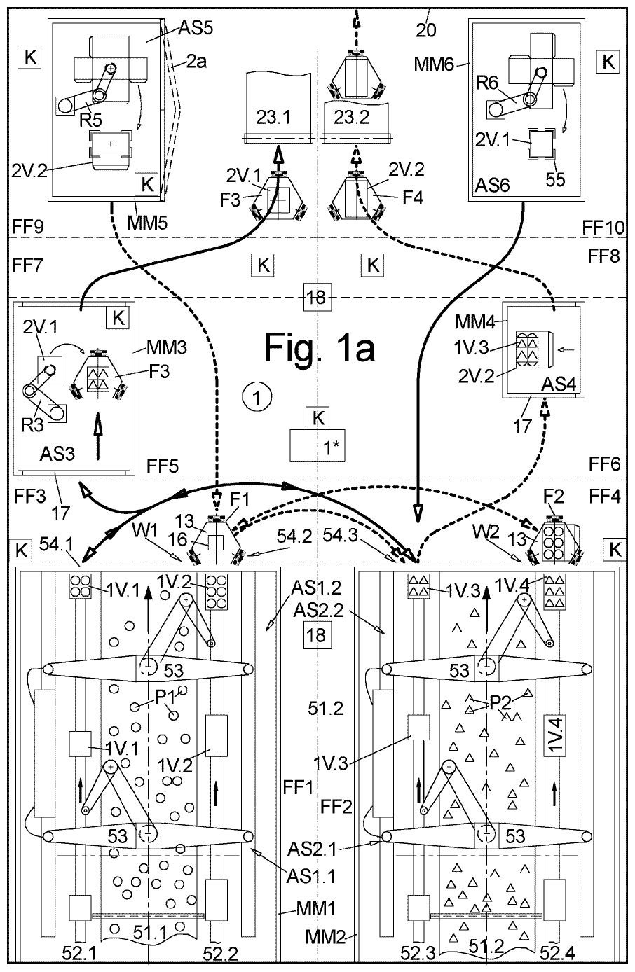

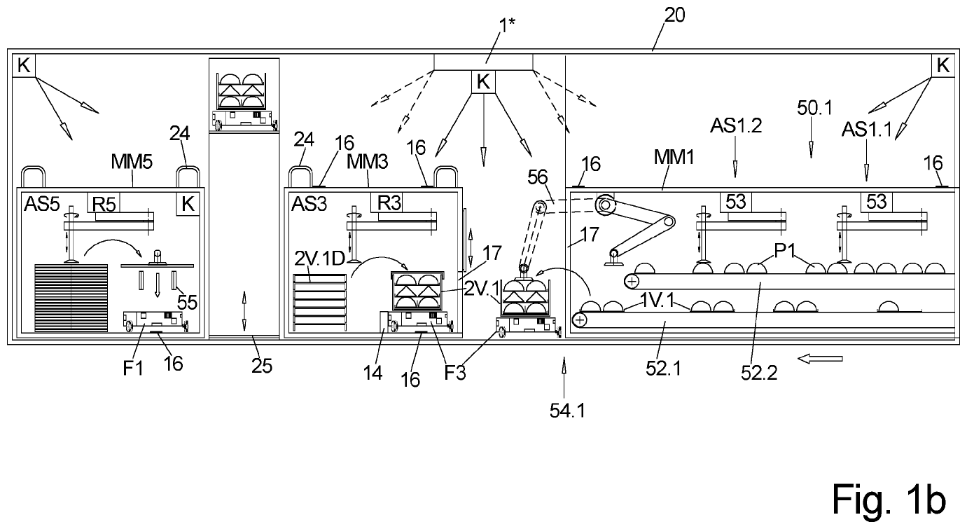

FIG. 1a: Top view of a packaging machine system in a hall,

FIG. 1b: Side view of the system in FIG. 1a from the left,

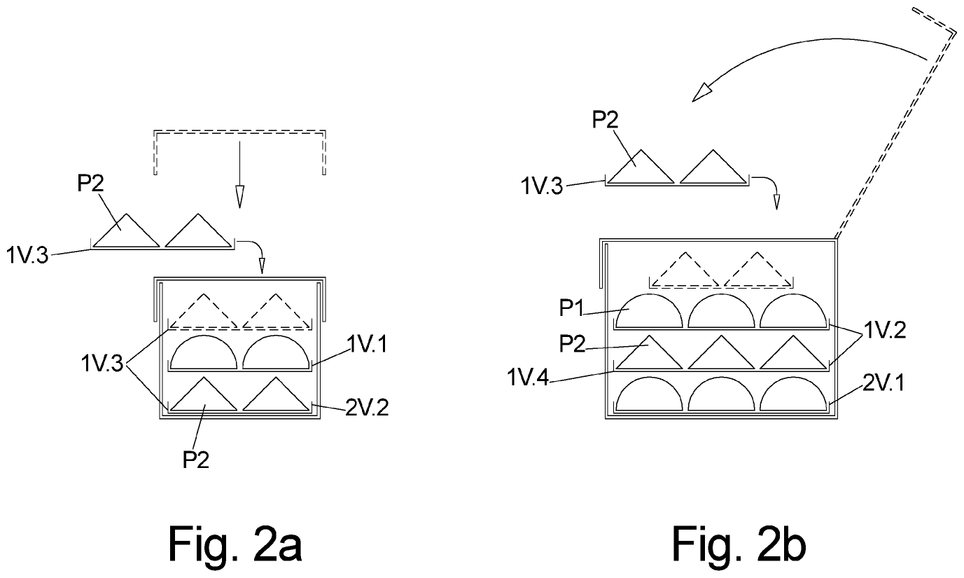

FIG. 2a, b: Two different secondary packages in side view, cut open, with different primary packages inside,

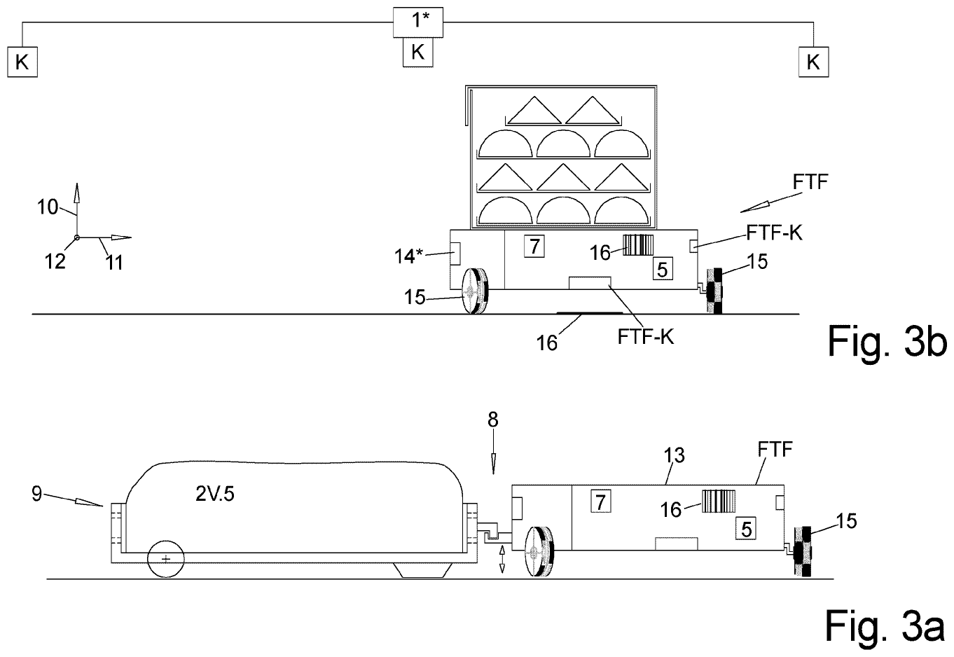

FIG. 3a, b: Side view of one of the driverless transport vehicles, individually and with a trailer coupled to it,

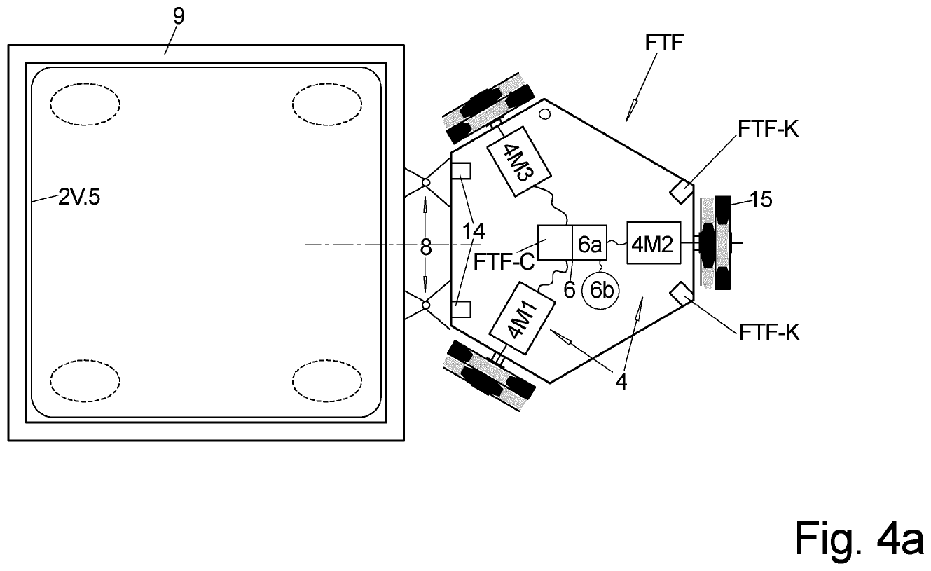

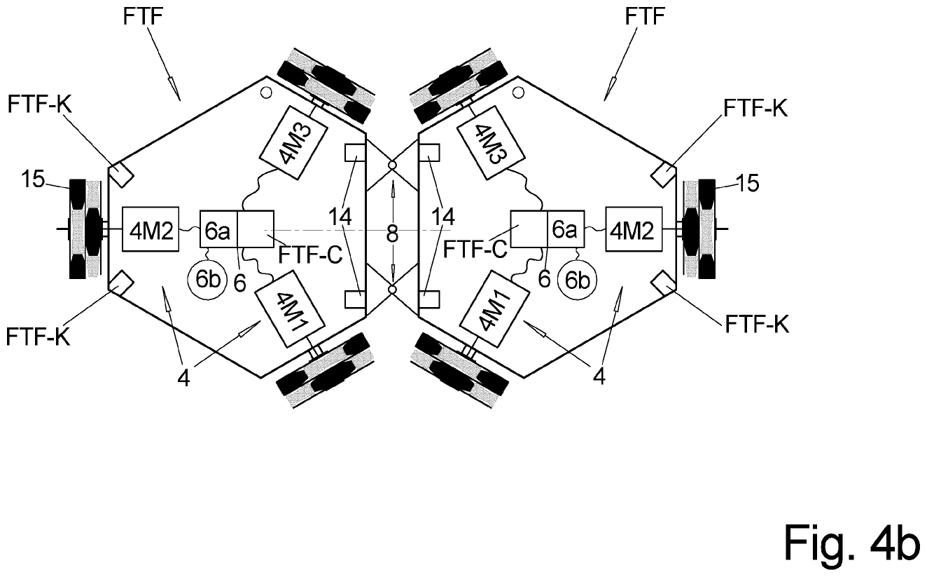

FIG. 4a: Top view of the vehicle/trailer combination according to FIG. 3a,

FIG. 4b: Two AGVs connected to each other,

FIGS. 1a, b show a packaging machine system 1 which is arranged in a hall 20 and comprises multiple machine modules MM1 to MM6 which are arranged distributed in the hall 20 and are each surrounded by a safety enclosure 2 with safety doors 2a arranged therein, so that people cannot come into contact with the workstations AS1, AS2 arranged therein during operation, because when a safety door 2a is opened, the workstations AS1, AS2 located therein are immediately brought to a standstill.

The purpose of system 1 is to fill different secondary packages 2V with primary packages 1V, which in turn are initially filled with different products P1, P2, and to close these secondary packages 2V and transfer them to one of the two discharge conveyors 23.1, 23.2, which transport them away, possibly out of hall 20.

The two different secondary packages 2V.1, 2V.2 to be handled in this case are transported back and forth within the hall 20 between the individual machine modules MM1 to MM6 by automated guided vehicles—AGVs for short—which can be moved independently of one another on the hall floor under remote control from a central control unit 1*, whereby in this case the top of the AGV serves as a storage surface 13 on which the transported goods, in this case the secondary package, are placed for transportation.

In this case, the two different products P1, P2 are transported—preferably from outside the hall 20—on two different product conveyors 51.1, 51.2 running parallel to each other and are each gripped by a so-called picker line or robot line 50.1, 50.2, comprising multiple transfer robots 53, so-called pickers, one behind the other in the direction of travel of the product conveyors 51.1, 51.2 and transferred into primary packages 1V.1 to 1V.4.

For this purpose, serial F5 robots 53 with upper arm and lower arm are shown, the arm parts of which can be swiveled in relation to each other about vertical axes and in which, in addition, as 4th and 5th axes, the arm parts can be swiveled in relation to each other. degree of freedom, the vertical strut at the free end of the forearm can be moved in height and rotated about the vertical axis in a controlled manner.

On both sides of each of the two product belts 51.1, 51.2 runs a packaging belt 52.1, 52.2 or 52.3, 52.4, on which—in this case running in the same direction as the product belt—the open-top, tray-shaped primary packages 1V.1 to 1V.4 run alongside the product belt, so that at the end they are completely filled with products from the adjacent product belt.

In both picker lines 50.1, 50.2, trays, i.e. primary packaging 1V.1, 1V.3, are fed in on one side, each of which can hold four products arranged in a rectangle, and trays 1V.2, 1V.4, each of which can hold six products in two rows of three, are fed in on the other side.

The aim is to place multiple such filled primary packages 1V.1, 1V.2 in multiple layers on top of each other in appropriately dimensioned secondary packages 2V.1 or 2V.2, as shown in FIGS. 2a, 2b, until the secondary package is completely filled.

FIG. 2a shows that three layers of filled tray-shaped primary packaging 1V.1, 1V.3, 1 V.1 are to be arranged one above the other in carton 2V.2 as secondary packaging in the filled state, i.e. the middle layer is filled with products P1 and the bottom and top layers are filled with products P2.

According to FIG. 2b, the cartons 2V.1 should have four layers of tray-shaped primary packaging on top of each other as secondary packaging, the bottom three of which should each contain one of the 6 products in primary packaging 1V.2, 1V.4, 1 V.2 and the top, 4th layer of primary packaging 1V.3. Layer one primary packaging 1V.3 with only four products on it. Here too, the products should alternate from layer to layer, starting with product P1 in the bottom layer.

For this purpose, an AGV, for example the vehicle F3, first drives to the machine module MM6, in which there is only a single work station AS6, in which a robot R6 removes the uppermost blank from a stack of flat cardboard blanks and presses it through a matrix 55, thereby erecting it into a cardboard box open at the top as secondary packaging 2V.1, whereby its walls are also glued together.

The erected carton 2V.1 with space for four products arranged in a square is then transferred to the vehicle F3—waiting in the machine module MM6, preferably under the mattress 55, or waiting in front of an airlock of its enclosure 2—which can be performed by the same robot R6 or by another robot within the machine module MM6 or by another handling means such as a conveyor belt or a chute.

The vehicle F3 drives with the semi-mounted, still empty secondary packaging 2V.1—which can be held on it, for example by suction cups-to the primary packaging outlet, in future P-V outlet for short, 54.3 of the right-hand picker line 51.2 and receives the tray-shaped primary packaging 1V.3 filled with products P2 there—from a robot 56 shown only in FIG. 1b.

Such a robot 56—which is present at the end of each of the two picker lines 50.1, 50.2—is shown as a serial F2 robot with upper arm and lower arm, in which the two parts are pivoted relative to each other and to the robot base about horizontal pivot axes and have only 2 degrees of freedom-horizontally transverse to the pivot axis and vertically.

This vehicle, e.g. F3, then travels to the P-V outlet 54.1, where it receives the next tray 1V.1, but filled with products P1, and back again at outlet 54.3 another tray 1V.3 filled with product P2.

With the secondary packaging 2V.1 now completely filled as shown in FIG. 2a, the vehicle F3 moves through an airlock 17 into the machine module MM3, in which there is a work station AS3 consisting of a robot R3, which picks up a separate carton lid 2V.1D and places it on the filled secondary packaging 2V.1 and closes it while this secondary packaging is on the vehicle F3.

Accordingly, the vehicle F3 must be positioned very precisely in MM 3 for this purpose, for which, as shown in FIG. 1b, a target marking 16 is applied to the floor inside the machine module MM 3—if this has a floor plate on the upper side of the floor plate or if the frame of the machine module MM3 ends at the bottom with freely extending columns, on the floor of the hall 20—a target marking 16, for example in the form of a QR code 16, is applied at a defined position, which the AGV camera AGV-K on the underside of the vehicle F3, which is directed towards the floor, can recognize and the on-board control unit of the vehicle F3 can automatically position itself exactly above it and in the correct rotational position around the vertical axis and thus in exactly the right position for placing the cover 2V.1D, at least if the filled secondary packaging 2V. 1 is in the intended target position on the vehicle F3.

This, in turn, can be a machine module MM3 located above this vehicle position on a high-flying. Verify the arranged camera K and initiate a corrective movement of the vehicle F3 via the central control unit 1* in the event of a deviation.

If there is no target marking in the AS3 work station, the exact positioning of the secondary packaging is carried out exclusively via the elevated camera, which is preferably mounted on the frame of the MM 3 machine module.

Such target markers on the ground are preferably present in or at each of the waiting positions where AGVs wait to perform handling on their cargo.

Furthermore, such a target marking 16 can also be present on the, in particular each, of the machine modules, preferably on the upper side of their frame, whereby the exact position of each of the machine modules in the hall 20 can be determined by the central control unit 1* by means of the cameras present above it, preferably on the hall ceiling, which can be done automatically, for example after a changeover of the machine modules to a new packaging machine system.

The machine modules can be moved easily, for example by moving them using a forklift truck—after disconnecting their supply lines, which usually extend from the hall ceiling—for which purpose, for example, transport eyelets 24 are provided on the top of the frame of each machine module, so that the floor of the frame—if present at all—can be extremely thin, making it easy to drive an AGV onto the floor of a machine module.

However, the frame of a machine module can also end at the bottom with freely extending support columns that stand on the hall floor, so that this also forms the driving surface for the AGVs within the machine module.

FIG. 1b also shows that a recharging module 14 is present in the workstation AS3 at such a position that, when the vehicle is correctly positioned for placing the lid, its energy storage unit 6 is recharged via the recharging contacts 14* of the AGV, in particular by the recharging contacts 14* being in contact with the recharging module 14.

This can also be present at or in every work station.

The vehicle F3 with the filled and sealed carton 2V.1 on it then moves on to the discharge conveyor 23.1, where the carton 2V.1 is transferred as secondary packaging by any handling means—which can also be part of the vehicle F3—to the discharge conveyor 23.1, which transports it further away, for example to an adjacent hall where the filled and sealed secondary packaging is palletized or combined into other larger containers.

Of course, there is not just one vehicle F3 as an AGV on the route described above, but many of them, at least as many as there are machine modules on the route described.

FIG. 1a also shows the analogous process of the secondary packaging 2V.2, which is completely filled with primary packagings 1V.2 and 1V.4 as well as 1V.3, and which is correspondingly
erected in the machine module MM 5 as an open-top carton 2V.2 and handed over to one of the vehicles, e.g. F4, which
then takes over three primary packings 1V.2, 1V.4 and again 1V.2 alternately one after the other at the P-V outlets 54.2 and 54.4,
then moves to the P-V outlet 54.3 to pick up a filled primary packaging 1V.3, from there with the completely filled secondary packaging 2V.2 into the machine module MM4, in whose work station AS4 the lid already integrally present on the open carton 2V.2 is closed by means of a handling unit not shown, again while this secondary packaging 2V.2 is on the vehicle, e.g. F4, and
after closing the secondary packaging, the vehicle F4 either travels to a discharge conveyor 23.2 in the same way as the discharge conveyor 23.1 and its load is transferred to the latter or leaves the hall 20 through an airlock 17 in the wall of the hall 20 and travels along—in particular a physically formed travel path 22, which can be closed in a tunnel-like manner, for example, as additionally shown in FIG. 1b with respect to FIG. 1a—to an adjacent hall for the purpose of palletizing the filled cartons 2V.2.

In FIG. 1b, the tunnel-like path of travel 22 is at a height above head height, namely just below the height of the hall ceiling. The AGVs traveling on the floor of the hall can be brought from the floor of the hall 20 to the height of the elevated track 22 by means of a lift 25, also shown in FIG. 1b, which is also controlled by the central controller 1* in temporal coordination with the travel movements of the AGVs.

In this way, AGVs can drive between different halls 20 without disrupting pedestrian and low vehicle traffic between the halls.

To cover greater distances, these travel paths 22 can contain not only stationary travel surfaces for the AGVs, but also conveyor belts on which the AGVs are either transported stationary or additionally travel on them in the desired transport direction.

FIGS. 3a, b and 4a, b show AGVs in side view and in top view of its storage surface 13.

As can be seen, such an AGV in this case has the shape of a non-regular hexagon when viewed from above, on each of whose second, the three shorter, sides in the circumferential direction there is a wheel 15, the three axes of rotation of which preferably intersect when viewed from above.

Each wheel 15 is designed as a so-called all-directional wheel 15, in the circumferential surface of which spherical, barrel-shaped rollers with barrel rotation axles running tangentially to the wheel 15 are mounted, whereby such an all-directional wheel 15 can travel in all directions without significant slippage.

Symbolically illustrated, such an AGV comprises a storage surface 13 under its preferably flat upper side, which preferably also has no raised edge, so that transported goods can also be placed on it, which protrude above the storage surface 13 when viewed from above,
a travel drive 4 with 15 separately controllable travel motors 4M1-4M3 per wheel,
an energy storage unit 6 for the AGV in the form of a supercup 6a and an electric battery 6b as an emergency battery,
an acceleration sensor 5, which measures the acceleration of the AGV including its duration,
communication means 7, in particular a radio antenna and a radio transmitter,
two trailer couplings 8 next to each other in one of the outer sides of the AGV seen in the top view,
at least one recharging contact 14* for contacting a recharging station 14 of the system, in particular at one of the waiting positions W1, W2 for AGVs in or on one of the machine modules.
one or more AGV cameras AGV-K, which, however, are only designed to recognize predefined environmental patterns such as a QR code with regard to their image evaluation unit.
Such an AGV camera can be directed towards the ground in order to recognize a QR code applied there, for example, as a target marker for the exact positioning of the AGV, or also looking horizontally from the AGV in order to recognize and precisely approach a target marker applied to a component in the environment, such as a workstation, for the exact positioning of the AGV.

FIGS. 3a and 4a show in side view and top view that the AGV can automatically couple and move a trailer 9 by means of its one or preferably both trailer couplings 8, on which, for example, a secondary packaging 2V.5 can be stored.

Thus, the trailer coupling 8 of the AGV can be lowered and positively connected by lifting a counter element of the trailer 9 from below, lifting this side of the trailer 9 and corresponding adjustable feet under the trailer 9 from the ground, whereupon the trailer 9 can be easily moved by the AGV by means of the wheels arranged at the end facing away from the coupling.

FIG. 4b also shows that two AGVs can also be connected to each other to form a rigid unit—in particular by means of the same trailer coupling—whereby larger and heavier loads can be transported by such a combination of two AGVs, for which the two coupled AGVs can be controlled synchronously by the central control unit 1*.

### REFERENCE LIST

1 Packaging machine plant, plant
1* Central control unit
2 Safety enclosure
2a Security door
3 Navigation system
4 Drive
4M1,4M2 Motor
5 Acceleration sensor
6 Energy storage
6a Supercup, electric capacitor
6b Electric battery
7 Means of communication, sender/receiver
8 Trailer coupling
9 Trailers
10 Vertical
11 1st horizontal direction
12 2nd horizontal direction
13 Storage area
14 Reloading device
15 All-direction wheel
16 Target marking
17 Lock
18 Permanent obstacle
19 Temporary obstacle
20 Hall
21 Positioning device
22 Physical route
22.1, 22.2 Travel path module
23.1.23.2 Conveyor
24 Transport eyelet
25 Lift
50.1.50.2 Picker route, Robot route
51.1.51.2 Product tape
52.1-.4 Packaging tape
53 Robots, Pickers
54.1-.4 Primary packaging outlet, P-V outlet
55 Matrix
56 Robots
AS1, AS2 Workstation
Delta difference
FF Driving surface area, driving surface
FF1, FF2 Driving surface sector, sector
F1, F2 Vehicle, AGV
AGV-C AGV onboard control system
AGV-K AGV environmental sensor, AGV camera
AGV-R AGV handling unit, AGV robot
AGV-S AGV cleaning unit, AGV vacuum cleaner
h Mounting height camera, height
H Maximum height module
K Position detector, camera
MM1, MM2 Machine module
P, P1, P2 Product
R1, R2 Handling unit, robot
QR Predefined environment pattern, QR code
1V, 1V.1, 1V.2 Primary packaging, tray
2V, 2V.1, 2V.2 Secondary packaging, cardboard
W1, W2 Waiting position

1. Packaging machine installation, in particular for filling secondary packages, in particular cartons, with products which have already been primarily packaged, comprising:
one or more machine modules, the outer sides of which are closed in particular by safety doors;
at least one work station within a machine module, each with at least one movable handling unit, in particular a robot, with a tool for handling or processing products or packages;
a transport system with driverless transport vehicles that can be moved freely and independently of one another under remote control for transporting at least one item to be transported, such as a product or a package, between the individual work stations within a machine module and/or between the machine modules;
a central control unit located away from the AGVs to control the AGVs with a wireless signal connection to the AGVs; and
position detectors, in particular cameras, for determining the current position of the individual AGVs, in particular the transported goods on them, within the system,
wherein:
the central control unit is designed in such a way that it is able to control the movements of the handling units in a coordinated manner, knowing the spatial positions, i.e. the positions and/or rotational positions, of the AGVs, in particular the spatial positions of their load.

2. Packaging machine installation according to claim 1,
wherein:
the central controller is designed such that it and in particular only it comprises a navigation system which can determine the position of the AGVs by means of the position detectors and from this can determine a route to a destination and can send a corresponding route command, in particular including local and also time specifications, to the relevant AGV and
an on-board controller of the AGV is designed in such a way that it can only control the travel drive on the basis of the travel path command in such a way that the specified travel path is traveled in accordance with the travel path command.

3. Packaging machine installation according to claim 1,
wherein:
the central control unit and the onboard control unit are designed so that they are capable of detecting the actual position of an AGV by means of the position sensors and, in the event of a deviation from the target position, in particular on the target travel path, to send a correction travel command to the AGV, with the aid of which the AGV travels to the target travel path, in particular to the target position;
and/or
if the position detectors of the central controller fail, the on-board controller determines the actual position of the AGV on the basis of the control commands issued to the travel drive since the last target/actual comparison or the wheel movements of the travel drive;
and/or
if the signal connection between the central controller and the AGV and the known destination fails, but there are no further travel commands, the on-board controller is able to determine the straight path between the current position of the AGV and the destination and issue corresponding control commands to the travel drive.

4. Packaging machine installation according to claim 3,
wherein:
the central control unit and the onboard control unit are designed in such a way,
that in the event of a failure of the position detectors of the central controller, the onboard controller determines the actual position of the AGV using the acceleration profile of the AGV recorded since the last target/actual comparison with an acceleration sensor;
and/or
if the signal connection between the central controller and the AGV fails and the destination is known, but no further travel commands are issued, the on-board controller is able to determine the straight path between the current position of the AGV and the destination, issue corresponding control commands to the travel drive and check the current position of the AGV on the way to the destination using the acceleration profile recorded since the last target/actual comparison with an acceleration sensor.

5. Packaging machine installation according to claim 1,
wherein:
the AGVs have a controllable travel drive, an energy storage unit and communication means for the wireless data connection with the central controller and
the AGVs have at most one environment sensor, in particular a camera , for detecting the environment, the image evaluation unit of which is at most capable of recognizing a predefined environment pattern, such as a barcode or QR code, but no unknown environmental features.

6. Packaging machine installation according to claim 1,
wherein:
the energy storage system comprises super caps and an emergency battery, which are dimensioned in such a way that the AGV can reach the next recharging station from any position within the system.

7. Packaging machine installation according to claim 1,
wherein:
each of the AGVs have an automatically functioning and/or controllable trailer coupling for automatically coupling or uncoupling a trailer and/or another AGV.

8. Packaging machine installation according to claim 1,
wherein:
the position detectors, in particular cameras, of the central control system within the system, are preferably outside the machine modules and are also available within the machine modules, especially at a height above the maximum height of the machine modules.

9. Packaging machine installation according to claim 1,
wherein:
the top of the AGV or trailer serves as a storage surface for the transported goods, in particular the movable part of the handling unit, in particular the robot arm, is located for the most part at a height above the storage surface.

10. Packaging machine installation according to claim 1,
wherein:
the work stations have a contacting or contactless electrical recharging device at the waiting positions;
and/or
the entire possible driving area of the AGV is virtually divided into sectors and the route commands for the AGV are defined sector by sector, in particular, a transfer of an AGV from one sector to the next is defined both in terms of location and time and is controlled by the central control system as a target/actual comparison;
and/or
the image evaluation of the cameras used as position sensors for the position of the AGV and the position of obstacles is carried out using artificial intelligence;
and/or
driving surfaces for the AGVs are available on multiple levels, one above the other, in particular, the change from one floor to the other takes place via a lifting device, in particular an elevator, which is scheduled into the travel path commands from the central controller in terms of location and time, preferably not via inclined ramps;
and/or
the driving surfaces for the AGVs are moving driving surfaces;
and/or
guard rails for the AGVs are provided on one or both sides of the travel paths for the AGVs;
and/or
there are driven drivers for the AGVs on the system side along the travel paths for the AGVs;
and/or
Driving surfaces for the AGVs are separated at least visually, in particular physically, from walking surfaces for people;
and/or
the travel drive of an AGV is designed so that it can turn on the spot and travel in any direction from a standing position, in particular in that the AGV has all-directional wheels;
and/or
the AGV has its own handling unit, in particular a robot, which in particular is also controlled from the central control system;
and/or
the AGV has its own cleaning unit for cleaning the travel paths, in particular a brush and/or suction unit, which in particular is also controlled from the central control unit;
and/or
the AGV has a target marker for scanning by the position sensors of the central controller.

11. Packaging machine installation according to claim 1,
wherein:
the work stations, in particular at or in their, preferably lockable, airlock for the entry of an AGV, have a target marking that can be scanned by the AGV, in particular optically visible.

12. Method for operating a packaging machine installation and, in particular, its transport system, the packaging installation comprising:
multiple work stations, each with at least one movable handling unit, in particular a robot, with a tool for handling or processing products or packaging;
a transport system with freely and independently movable, driverless, remote-controlled transport vehicles for transporting products or packaging, in short a transport good, between the individual workstations;
a central control system located away from the AGVs to control the AGVs;
position detectors, in particular cameras, for determining the current spatial position of the individual AGVs, in particular the transported goods on them, within the system, in particular of a packaging machine system according to claim 11,
wherein:
the spatial positions, i.e. positions and/or rotational positions viewed from above, and in particular the movements of the AGVs and, in the case of loaded AGVs, in particular the transported goods lying on them, are monitored centrally and in real time and
the handling units are centrally controlled in synchronization with the spatial positions and in particular the movements of the AGVs.

13. Method according to claim 12,
wherein:
the AGVs receive travel path commands from the central controller, in particular drive commands for the travel drive, in particular for each individual drive motor, preferably for the entire travel path to the destination;
corrected route commands for the rest of the route are sent to the AGV by the central controller, especially if the situation changes; and
the drive commands in particular each contain an energy supply profile as a function of time, in particular from the start time.

14. Method according to claim 13,
wherein:
the actual spatial position of an AGV is determined by means of the position sensors and, in the event of a deviation from the target spatial position, in particular on the target travel path, a correction travel command is sent to the AGV by the central controller, with the aid of which the AGV travels to the target travel path, in particular to the target position;
and/or
if the position sensors of the central controller fail, the on-board controller determines the actual spatial position of the AGV based on the control commands issued to the traction drive since the last target/actual comparison or the wheel movements of the traction drive;
and/or
if the signal connection between the central controller and the AGV and the known destination fails, but no further route commands are issued, the on-board controller determines the straight route between the current position of the AGV and the destination and issues corresponding control commands to the drive.

15. Method according to claim 14,
wherein:
if the position sensors of the central controller fail, the on-board controller determines the actual position of the AGV using the acceleration profile of the AGV recorded since the last target/actual comparison with an acceleration sensor;
and/or
if the signal connection between the central controller and the AGV and the known destination fails, but no further travel path commands are issued, the on-board controller determines the straight path between the current position of the AGV and the destination and issues corresponding control commands to the travel drive and checks the current position of the AGV on the way to the destination using the acceleration profile recorded since the last target/actual comparison with an acceleration sensor.

16. Method according to claim 1,
wherein:
the AGVs at the waiting positions, in particular in the work stations, are recharged electrically by contact or contactless charging;
and/or
the entire possible driving area of the AGV is virtually divided into sectors and the route commands for the AGVs are defined sector by sector,
in particular, a transfer of an AGV from one sector to the next is defined both in terms of location and time and is controlled by the central control system as a target/actual comparison;
and/or
the image evaluation of the cameras used as position sensors for the position of the AGVs as well as the position of obstacles is carried out using artificial intelligence.

17. Method according to claim 16,
wherein:
shortly before loading an AGV, its spatial position is determined as accurately as possible, in particular by means of a positioning device in a work station;
the spatial position of the transported goods on the AGV is determined immediately after loading; and
the position difference can be stored for controlling the position of the transported goods to and at the destination.

18. Method according to claim 17 by converting the packaging machine installation by:
the desired new work order is entered in the central control unit;
the transportable machine modules, in particular those that can be transported by forklift truck, are moved to a new position within the packaging machine system, in particular automatically, in particular under activating or adding new machine modules or removing or deactivating machine modules that are no longer required;
the central controller determines the exact position of the machine modules by means of position sensors, in particular cameras, in particular the same position sensors as are used to determine the position of the AGVs, in particular using target markings on the modules; and
the central control system automatically determines the required quantity and controls it accordingly in synchronized interaction with the processing stations.

19. Method according to claim 18,
wherein:
if physical travel paths are present or required for the AGVs, these are arranged, in particular between the work stations, in particular arranged automatically, in particular automatically assembled from travel path modules.
